(19) United States
(12) Patent Application Publication
(10) Pub. No.: US 2021/0120797 A1
(43) Pub. Date: Apr. 29, 2021

(54) ICE FISHING TIP-UP DEVICE

(71) Applicant: Savchenko Aleksandr, New York, NY (US)

(72) Inventor: Savchenko Aleksandr, New York, NY (US)

(21) Appl. No.: 16/664,809

(22) Filed: Oct. 26, 2019

(51) Int. Cl. A01K 97/01

(52) U.S. Cl. CPC A01K 97/01

(57) ABSTRACT

The present invention relates to ice fishing devices. The present invention comprises a base and a cover, connected to each other by locks, a signal flag, a shaft. On one end of the shaft is a reel for a winding fishing line with a fishing hook, on another end a washer with a flag fixing element. On the base is made a window, around said window are placed supports for the shaft with the reel. An insulating spacer is placed in a space between the cover and the base. The flag is installed by one end in the groove of the cover, and at the other end a hole is made for interacting with the flag fixing element. A reflective coating 3M is installed on the flag. The base, cover, signal flag and shaft are made of frost-resistant plastic. The base and cover are cylindrical.

The present invention relates to ice fishing devices. The present invention relates to an ice fishing device which is of simple and inexpensive construction.

### 2. DESCRIPTION OF THE PRIOR ART

The use of ice fishing devices is known in the prior art. More specifically, ice fishing devices heretofore devised and utilized are known to consist basically of familiar, expected and obvious structural configurations, notwithstanding the myriad of designs encompassed by the crowded prior art which have been developed for the fulfillment of countless objectives and requirements.

This invention relates to an ice fishing tip-up. When fishing in the winter, ice fishermen typically drill or cut a hole in the ice to fish in. To increase their chances of catching fish, ice fishermen typically use more than one hole to fish out of simultaneously. It is well known in the prior art to use a device called a “tip-up” to signal that a fish has struck the hook. A fisherman who is using a number of tip-ups is able to position himself in a stationary spot while monitoring several fishing holes located around him. A further refinement in ice fishing apparatus is a housing that covers the hole in the ice. The housing contains the fishing gear itself, such as a reel, as well as portions of a signaling device.

Known prior art ice fishing devices include many US patents, for example U.S. Pat. Nos. 4,953,317 and 5,598,656. Recent U.S. Pat. No. 4,953,317, which issued Sep. 4, 1990, discloses a special domed cover structure which has a projecting tube adapted to project downwardly through the hole and into the water in combination with an upper integrated dome cover which telescopes into the water projecting tube. The dome is particularly formed of a suitable material which will absorb and transmit impinging solar radiant energy into the air confined under the cover structure. The cover device serves to prevent the water from freezing within the opening and protect the fishing device during the fishing operation.

U.S. Pat. No. 5,598,656 includes an insulating heating structure integrated with a fish indicator. The device is comprised of a four-walled enclosure. Contained within the enclosure is a fishing structure consisting of a rotatable shaft and a spool containing fishing line which is used to catch the fish. Connected to the exterior of the enclosure is a fish indicator which is connected at one end to the wall of the enclosure and engages the portion of the shaft extending to the exterior of the enclosure. A cover is placed over the top surface of the enclosure to retain heat within the enclosure and prevent the ice fishing hole from freezing over. When a fish strikes the fishing line, the shaft rotates and releases the fish indicator, signaling to the fisherman that a fish has been hooked

One of the problems associated with the existing devices is the inability of other fisherman to see the devices in moving over the ice-covered lake. The complexity of certain devices result in a relatively costly construction from a manufacturing standpoint and a corresponding retail cost. Many ice fisherman are cost conscience and consequently cannot or will not purchase costly cover devices. Other devices do not appear to meet the demands of ice fisherman.

Despite the large number of existing ice fishing equipment, there nevertheless is need for improvement to them. There is therefore a continuing need for a simple, reliable and inexpensive unit.

### SUMMARY OF THE INVENTION

In accordance with the present invention, an ice fishing device is provided that includes more desirable features then were previously available. This is accomplished by devices that includes a housing that encloses a variable stiffness fishing line jigger. The present invention is particularly directed to a simple, but improved, effective ice fishing device which can be constructed and marketed as a reasonable cost and retail price. Generally, in accordance with the present invention a device for winter fishing comprising a base and a cover, connected to each other by locks, a signal flag, a shaft, on one end of the shaft there is a reel for a winding fishing line with a fishing hook, and on the other end is made a washer with a flag fixing element, and wherein on the base is made a window, around said window are placed supports for the shaft with the reel, and wherein a groove for setting the flag is made in the cover. It is also an object of the present invention to provide ice fishing device wherein an insulating spacer is placed in a space between the cover and the base.

It is a further object of the present invention to provide an ice fishing device wherein there is a gap to place the flag in a transportation position between the cover and the base

It is an additional object of the present invention to provide a ice fishing device wherein the flag being installed by one end in the groove of the cover, and at the other end a hole is made for interacting with the flag fixing element.

It is another object of the present invention to provide an ice fishing device wherein a reflective coating is installed on the flag.

Still another object of the present invention is to provide ice fishing device wherein the base, cover, signal flag and shaft are made of frost-resistant plastic.

Yet a further object of the present invention is to provide an ice fishing device 1 wherein the base and cover are cylindrical which is susceptible of a low cost of manufacture and sale.

Other advantages, benefits, and features of the present invention will become apparent to those skilled in the art upon reading the detailed description of the invention.

### BRIEF DESCRIPTION OF THE DRAWINGS

FIG. 1 is a perspective view of the preferred embodiment of the ice fishing device constructed in accordance with the principles of the present invention.

FIG. 2 is a perspective view of the preferred embodiment of the ice fishing device as on FIG. 1 when flag is on.

FIG. 3 is a side elevational view of the device

FIG. 4 is a top elevational view of the device

FIGS. 5 and 6 are a perspective view of the invention shown in the prior FIGS. 3 and 4 taken at line 5-5 of FIGS. 3 and 4.

FIGS. 7 and 8 are perspective view of the invention shown in the prior FIGS. 5 and 6 along arrow A and B.

FIG. 9 is an exploded perspective view of the device shown in the prior Figures.

The same reference numerals refer to the same parts through the various Figures.

### DESCRIPTION OF THE PREFERRED EMBODIMENT

With reference now to the drawings, the preferred embodiment of the new and improved ice fishing system embodying the principles and concepts of the present invention will be described.

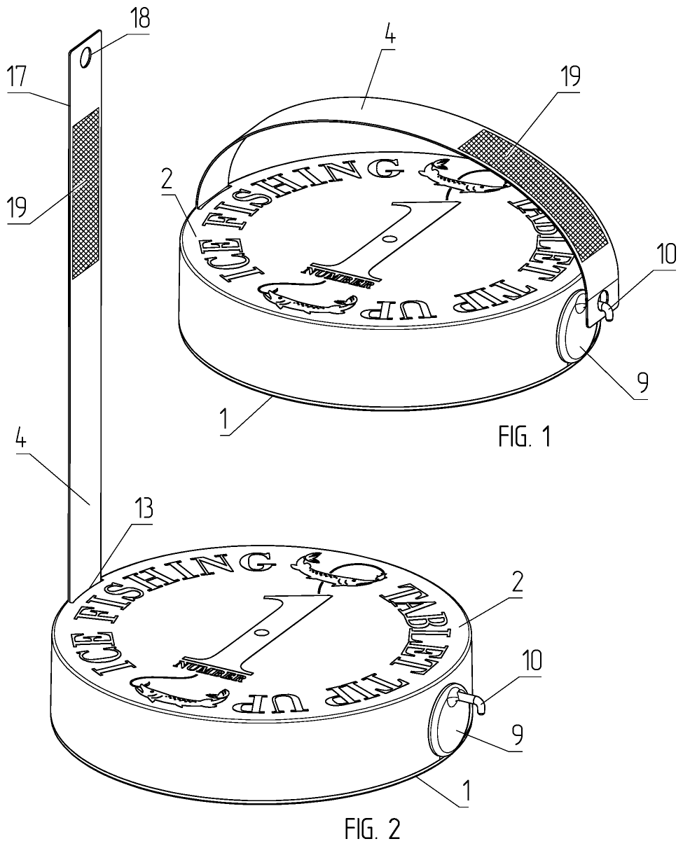

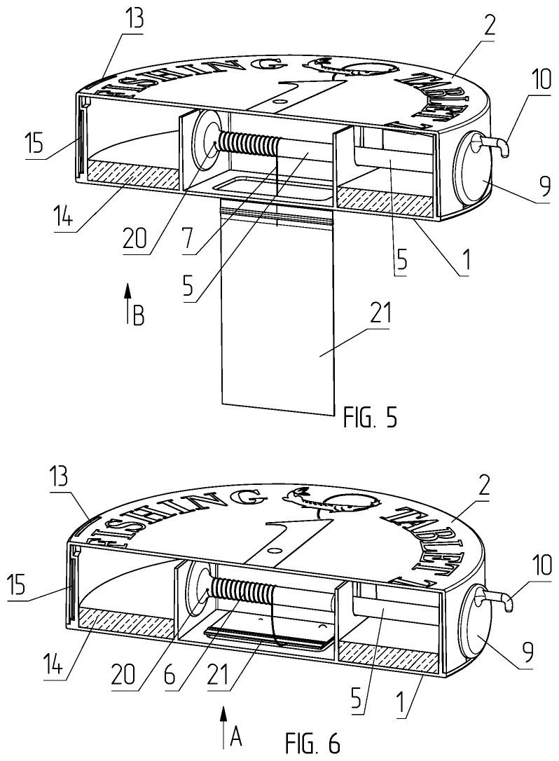

The present invention comprises a bottom base 1 and a top cover 2, connected to each other by locks 3 (FIG. 8), a signal flag 4 (FIGS. 1, 2, 3, 4 and 8), a shaft 5, on one end of the shaft 5 there is a reel 6 for a winding fishing line 7 with a fishing hook 8, and on the other end is made a washer 9 with a flag 4 fixing element 10 (FIG. 5, 6 [symbol] 8). The shaft 5 with the reel 6 for a winding fishing line 7 with a fishing hook 8, and the washer 9 with a flag 4 fixing element 10 may be made as one piece.

On the base 1 is made a window 11, around said window 11 are placed supports 12 for the shaft 5 with the reel 6, a groove 13 for setting the flag 4 is made in the cover 2 (FIG. 5, 6 [symbol] 8).

An insulating spacer 14 is placed in a space between the cover 2 and the base 1 (FIG. 5, 6 [symbol] 8).

There is a gap 15 to place the flag 4 in a transportation position between the cover 2 and the base 1 (FIG. 5, 6). The flag 4 is installed by one end 16 in the groove 13 of the cover 2, and at the other end 17 a hole 18 is made for interacting with the flag fixing element 10 in work position (FIG. 1, 2).

The reflective coating 19 is installed on the flag 4 (FIGS. 1, 2 [symbol] 8).

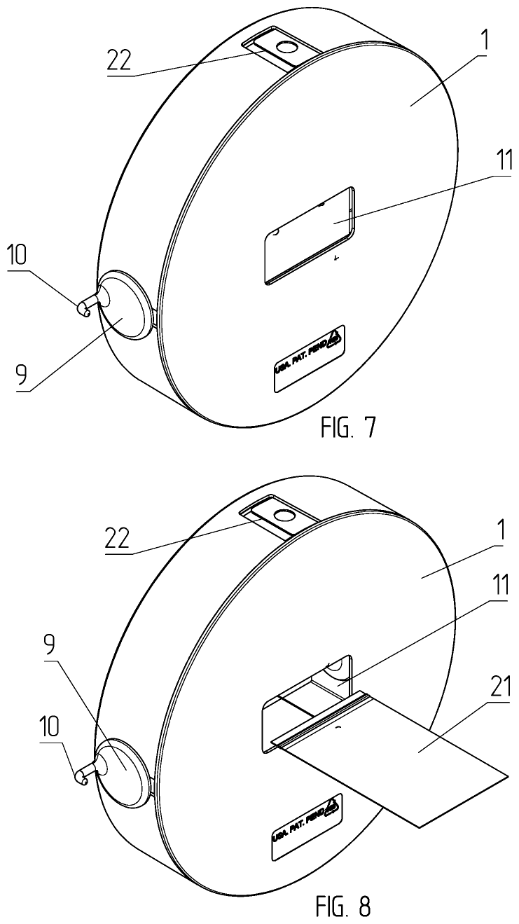

A hole 20 is made on the reel 6 for attaching the fishing line 7 (FIGS. 5, 6). The hook 8 and other fishing accessories can be placed in the plastic bag 21, which in the transport position can be located under the reel 6 (FIG. 7, 8).

The present invention relates to a portable ice fishing device and is directed to be used as following:

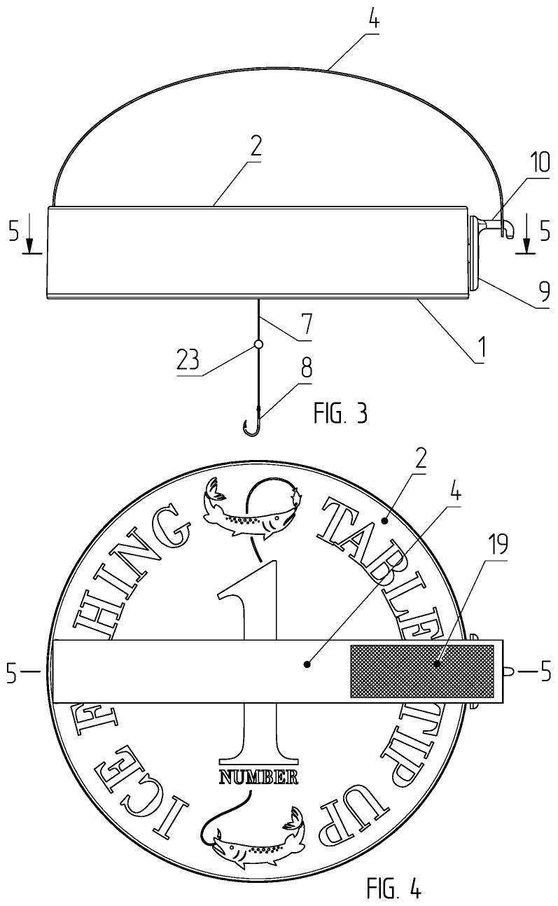

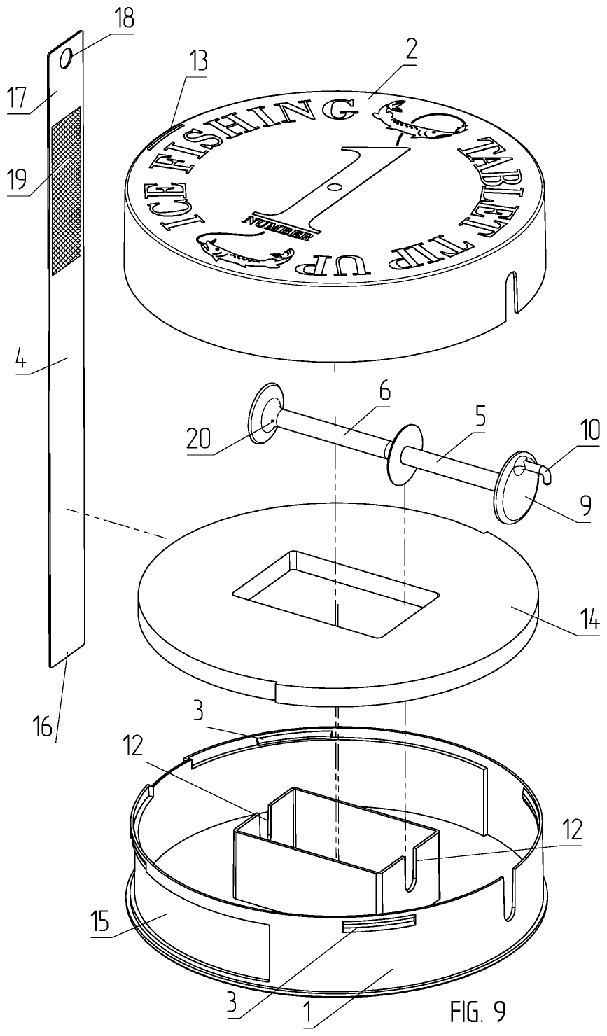

After a hole in the ice has been drilled or cut an ice fisherman collects the plastic bag 21 containing a hook 8 and a sinker/weight 23 (FIG. 3) from a base 1 lower compartment. The plastic bag 21 (FIG. 8) purposes are to prevent the hook 8 (FIG. 3) from tangling in the fishing Line/Rod 7 and to keep the hooks ultra-sharp for an extended time. Also a sinker/weight 23 attached to the fishing Line/Rod 7 sets the hook 8 and bait sink level. The next step is to fit the Flag 4 into the special groove 13 (FIG. 9). While one end 16 of the flag 4 (FIG. 9) is placed in the groove 13 on the cover 2, the other end 17 of the flag 4 is attached to the reel 6 that has a hook 10 (FIG. 9).

The ice fishing device according the present invention was made. In this prototype the flag 4 is made of plastic (Polycarbonate) and its dimensions are: thickness—0.040″−0.045″, length—16″-16.5″, width—1.5″. Polycarbonate is characterized to have properties of a strong/durable, flexible and frost-resistant material with high/low temperature resistance of −45 to +130 F and is approved for use by FDA. There is a retroreflective tape 3M 19 placed in the upper part of both sides of the flag 4. As the light from a flashlight hits the retroreflective tape on the Flag 4 (FIG. 9) in a low-light environment/at night, the flag is clearly visible from a large distance which allows to observe and control the device from a car, tent, etc. The special hook 10 located on the reel 6 not only serves a purpose of attaching the flag 4, but also is used for winding the fishing line/rod 7 on the reel 6.

The main feature of this device is that it does not contain any components made of metal which could otherwise be subject to corrosion. This feature enables to extend the service life of the device several times. The compactness of the device allows it to be disassembled for storing after exploitation in a very short time. The device comprises only five main components: base 1, cover 2, reel 5, insulation 14, flag 4. The base 1 and cover 2 are produced a disk-shaped housing for device.

The base 1, cover 2, reel 5 are made of in prototype from ABS (Acrylonitrile Butadiene Styrene) plastic that provides high/low temperature resistance of −45 to +130 F which enables the device to be used in winter temperatures.

A foam plastic Insulation 14 (FIG. 9) installed inside the base 1 prevents fishing hole water from freezing for a long time. That allows to keep an ice fishing hole continuously open.

The reel 5 has a special hole 20 (FIG. 9) that is used for securing the fishing line/rod 7 on. While in operating state the flag 4 is attached to fixing element 10 also works as a handle for carrying the device from place to place.

The hook 8 and the sinker/weight 23 can be packed back into the plastic bag 21 after ice fishing is complete. The plastic bag 21 (FIG. 8) then goes into the window 11 for storing. The Flag 4 (FIG. 9) is stored in the opening 22 (FIG. 7). In the event of the fishing line/rod 7 is needed to be changed, reach for the reel 6 through a window in the lower part of the base 1 which disengages the lock and opens the cover 2. The released reel 6 is then ready for a fishing line/rod 7 to be replaced.

The present inventive device is easy for manufacturing and operating which makes it available for use by a wide range of consumers interested in ice fishing.

While various changes may be made in the detailed construction, it shall be understood that such changes will be within the spirit and scope of the present invention as defined by the appended claims.

I claim:

1. A device for winter fishing comprising
a base,
a cover,
a signal flag and
a shaft,
wherein
the base and the cover connected to each other by locks,
a groove for setting the flag is made in the cover,
on one end of the shaft being made a reel for a winding fishing line with a fishing hook,
and on the other end being made a washer with a flag fixing element,
and wherein on the base is made a window, around said window are placed supports for the shaft with the reel.

2. The device according to claim 1 wherein an insulating spacer is placed in a space between the cover and the base.

3. The device according to claim 1 wherein there is a gap to place the flag between the cover and the base in a transportation position.

4. The device according to claim 1 wherein the flag being installed by one end in the groove of the cover, and at the other end a hole is made for interacting with the flag fixing element.

5. The device according to claim 1 wherein a reflective coating is installed on the flag.

6. The device according to claim 1 wherein the base, cover, signal flag and shaft are made of frost-resistant plastic.

7. The device according to claim 1 wherein the base and cover are cylindrical.
